(19) United States
(12) Patent Application Publication
(10) Pub. No.: US 2007/0035953 A1
(43) Pub. Date: Feb. 15, 2007

(54) Lamp module and projection apparatus using the same

(75) Inventors: Fu-Ming Chuang, Hsinchu (TW); Cheng Wang, Hsinchu (TW); Ting-Heng Hsieh, Hsinchu (TW)

Correspondence Address: BACON & THOMAS, PLLC, 625 SLATERS LANE, FOURTH FLOOR, ALEXANDRIA, VA, 22314, US

(73) Assignee: Young Optics Inc., Hsinchu (TW)

(21) Appl. No.: 11/486,292

(22) Filed: Jul. 14, 2006

(30) Foreign Application Priority Data
Aug. 12, 2005 (TW) 094127646

(51) Int. Cl. F21V 7/00

(52) U.S. Cl. 362/341

(57) ABSTRACT

A lamp module comprises a light source, a main reflector and an elliptical sub-reflector. The light source has a first arc and a second arc. The distance between the first arc and the second arc is an initial arc gap, and the light source is used for generating a light beam. The main reflector is used for reflecting the light beam and has a central axis, and the light source is disposed on the central axis. The elliptical sub-reflector is used for reflecting the light beam to the main reflector. The elliptical sub-reflector has a first focus and a second focus, a center of the light source is positioned on a long axis of the elliptical sub-reflector and between the first focus and the second focus, and a distance between the first focus and the second focus is larger than the initial arc gap.

### BACKGROUND OF THE INVENTION

1. Field of the Invention

The present invention relates to a lamp module and a projection apparatus using the same, and more particularly to a lamp module having an elliptical sub-reflector matched up with a main reflector and a projection apparatus using the lamp module.

2. Description of Related Art

Please refer to FIG. 1. FIG. 1 shows a structure of a lamp module of a conventional projection apparatus. A lamp module 100 comprises an arc lamp 110, an elliptical reflector 120 and a spherical sub-reflector 130. The arc lamp 110 is disposed on a central axis Z of the elliptical reflector 120. A light source, such as the arc lamp 110, a center O of the light source coincides with a first focus f1 of the elliptical reflector 120. The arc lamp 110 is used for generating a light beam L, and the elliptical reflector 120 is used for reflecting the light beam L and converging the light beam L into an integration rod 140 positioned on a second focus f2. A spherical center of the sub-reflector 130 is also positioned on the center of the light source 0 so as to reflect the light beam L generated from the arc lamp 110 back to the elliptical reflector 120.

In the conventional design of the elliptical reflector 120 in cooperation with the spherical retro-reflector 130, an arc gap Dg of the arc lamp 110 is very sensitive. The arc gap Dg of the arc lamp 110 gradually increases as time passes to cause the illumination efficiency of the lamp module 100 to be dropped down so that the use life of the conventional projection apparatus is decreased. Besides, the projection apparatus is developed toward miniaturization, the smaller the panel used by the projection apparatus is, the lower integration efficiency of the lamp module 100 becomes, and the shorter is the lifetime of the conventional projection apparatus.

### SUMMARY OF THE INVENTION

One object of the present invention is to provide a lamp module and a projection apparatus using the same, the lamp module comprises an elliptical sub-reflector in cooperation with a main reflector, and capable of increasing the illumination efficiency of an arc lamp and increasing the lifetime of the projection apparatus when a distance between first and second focuses of the elliptical sub-reflector is larger than an initial arc gap of the projection apparatus.

For attaining to another object of the present invention, the present invention proposes a lamp module, comprising a light source, a main reflector and an elliptical sub-reflector. The light source has a first arc and second arc. A distance between the first and the second arcs is an initial arc gap and the light source is used for generating a light beam. The main reflector is used for reflecting the light beam and has a central axis; the light source is disposed on the central axis. The elliptical sub-reflector is used for reflecting the light beam to the main reflector. The elliptical sub-reflector has a first focus and second focus, a center of the light source is positioned on a long axis of the elliptical sub-reflector and between the first and the second focuses, and the distance between the first and the second focuses is larger than the initial arc gap.

For attaining to yet another object of the present invention, the present invention proposes a projection apparatus, comprising a lamp module, an integration rod, a light valve, and a projection lens. The lamp module comprises a light source, a main reflector and an elliptical sub-reflector. The light source has a first arc and second arc. A distance between the first and the second arcs is an initial arc gap and the light source is used for generating a light beam. The main reflector is used for reflecting the light beam and has a central axis; the light source is disposed on the central axis. The elliptical sub-reflector is used for reflecting the light beam to the main reflector. The integration rod is used for converging the light beam reflected from the main reflector. The elliptical sub-reflector has a first focus and second focus, a center of the light source is position on a long axis of the elliptical reflector and between the first and the second focuses, and the distance between the first and the second focuses is larger than the initial arc gap. The light valve is disposed on a transmission path of the light beam from the integration rod for converging the light beam from the integration rod into an imaging light beam, and the projection lens is disposed on a transmission path of the imaging light beam for projecting the imaging light beam onto a screen.

### BRIEF DESCRIPTION OF THE DRAWINGS

The present invention can be more fully understood by reference to the following description and accompanying drawings, in which:

FIG. 1 shows a structure of a lamp module of a conventional projection apparatus;

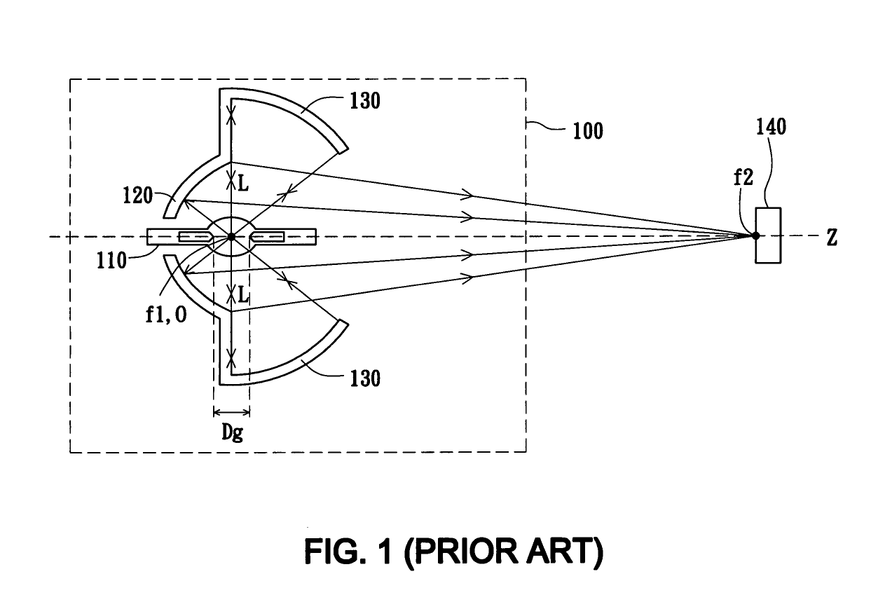

FIG. 2 is a schematic view, showing a structure of a lamp module of a projection apparatus of a preferred embodiment according to the present invention;

FIG. 3 is a data diagram, showing the relationship of the distance between first and second focuses of an elliptical sub-reflector and illumination efficiency of a lamp module when an initial arc gap of a lamp module shown in FIG. 2 is 1.0 mm; and

FIG. 4 is a data diagram, showing the relationship of the distance between first and second focuses of an elliptical sub-reflector and illumination efficiency of a lamp module when an initial arc gap of a lamp module shown in FIG. 2 is 1.3 mm.

### DETAILED DESCRIPTION OF THE PREFERRED EMBODIMENTS

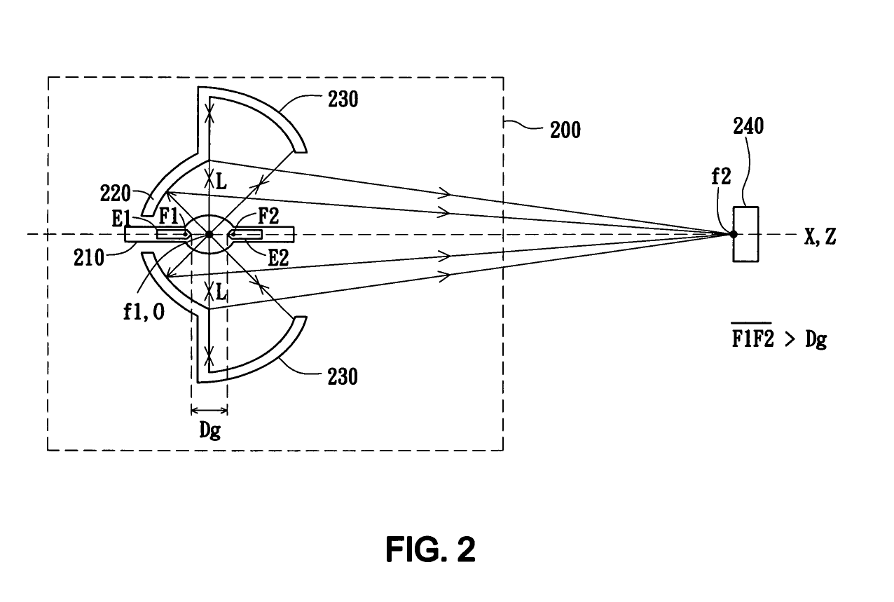

Please refer to FIG. 2. FIG. 2 is a schematic view, showing a structure of a lamp module of a projection apparatus of a preferred embodiment according to the present invention. A projection apparatus includes a lamp module 200, an integration rod 240, a light valve (not shown), and a projection lens (not shown). The lamp module 200 comprises a light source 210, a main reflector 220 and an elliptical sub-reflector 230. The light source 210, e.g. an arc lamp, has a first arc E1 and second arc E2. An initial arc gap Dg is a distance between the first arc E1 and the second arc E2. The main reflector 220, e.g. an elliptical reflector, has a first focus f1 and a second focus f2. The elliptical sub-reflector 230 has a first focus F1 and a second focus F2. The light source 210 is disposed on a central axis Z of the main reflector 220, and a center O of the light source 210 is positioned on the first focus f1 of the main reflector 220. A long axis X of the elliptical sub-reflector 230 coincides with the central axis Z, and the first focus F1 and the second focus F2 are respectively positioned at two sides facing each others outside the range of the gap of the first arc E1 and the second arc E2, i.e. a distance between the first focus F1 and the second focus F2 is larger than an initial arc gap Dg. The light source is used for generating a light beam L, and the main reflector 220 is used for reflecting and converging the light beam L into the integration rod 240. Besides, the elliptical sub-reflector 230 is used for reflecting the light beam L generated from the light source 210 back to the main reflector 220, and the light beam L is then reflected into the integration rod 240 through the main reflector 220 so as to increase the radiation efficiency of the light source 210. The light valve is disposed on a transmission path of the light beam L from the integration rod 240 for converging the light beam L from the integration rod 240 into an imaging light beam, and the projection lens is disposed on a transmission path of the imaging light beam for projecting the imaging light beam onto a screen (not shown).

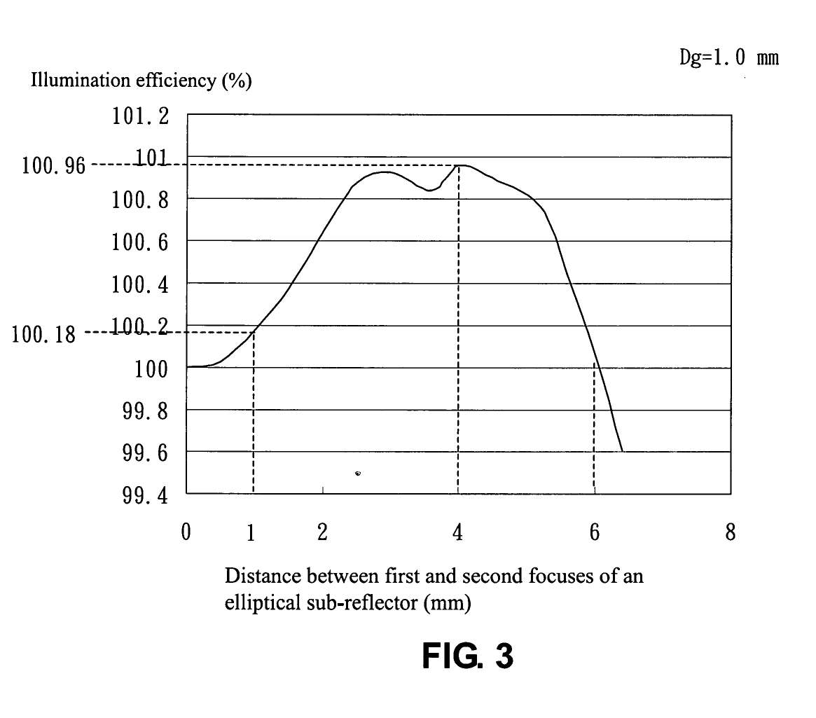

Please refer to FIG. 3. FIG. 3 is a data diagram illustrating a relationship of the distance between first and second focuses of the elliptical sub-reflector 230 and the illumination efficiency of the lamp module 200 when the initial arc gap Dg of the lamp module 200 shown in FIG. 2 is 1.0 mm. As FIG. 3 shows, taking the illumination efficiency of the same main reflector 220 in cooperation with a spherical sub-reflector, which focuses F1 and F2 are coincidental and the illumination efficiency is 100% as a standard. The larger the distance between two focuses F1 and F2 is, the higher the illumination efficiency of the lamp module 200 becomes. When the first and the second focuses F1 and F2 are respectively disposed on the ends of the range of the first arc E1 and the second arc E2 of the light source 210, i.e. when the distance between the first and the second focuses F1 and F2 is taken to be exactly equal to the initial arc gap Dg, the illumination efficiency approximate 100.18%, of the lamp module 200 is only higher than the illumination efficiency of the lamp module facilitated with the spherical sub-reflector a little, but it is not the optimized illumination efficiency. When the initial arc gap Dg is 1.0 mm, the optimized illumination efficiency of the lamp module 200 is 100.96% when the distance between the first and the second focuses F1 and F2 is 4 mm. Furthermore, all the luminous efficiencies of the lamp module 200 are higher than the illumination efficiencies of the lamp module using the spherical sub-reflector when the distance between the first and the second focuses F1 and F2 of the elliptical sub-reflector 230 is between 1.0 mm and 6.0 mm.

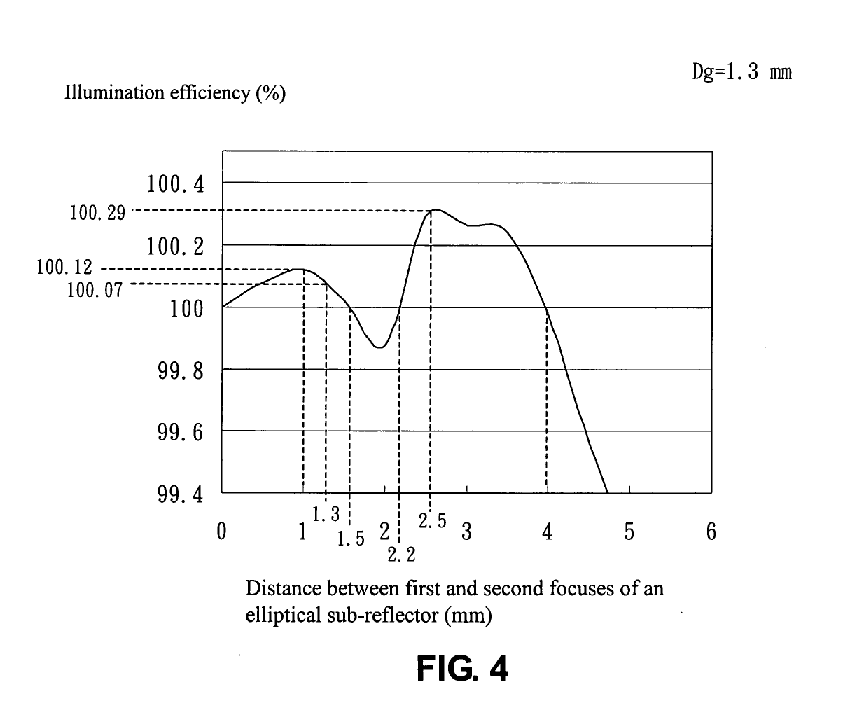

Please refer to FIG. 4. FIG. 4 is a data diagram illustrating a relationship of the distance between first and second focuses of an elliptical sub-reflector 230 and the illumination efficiency of a lamp module 200 when an initial arc gap Dg of a lamp module 200 shown in FIG. 2 is 1.3 mm. As FIG. 4 shows, taking a illumination efficiency of the same main reflector 220 in cooperation with a spherical sub-reflector, which focuses F1 and F2 are coincidental and the illumination efficiency is 100% as a standard. As the distance between the focuses F1 and F2 increases from zero, the illumination efficiency of the lamp module 200 has a tendency to increase. However, when the distance between the first focus F1 and the second focus F2 is between 1.5 mm and 2.2 mm, the illumination efficiency of the lamp module 200 contrarily decreases to be lower than the illumination efficiency of the lamp module using spherical sub-reflector. When the first and the second focuses F1 and F2 are respectively disposed on the top ends of the first arc E1 and the second arc E2 of the light source 210, i.e. when the distance between the first and the second focuses F1 and F2 is taken to be exactly equal to the initial arc gap Dg, which is 1.3 mm, the illumination efficiency approximate 100.07%, of the lamp module only higher than the illumination efficiency of the lamp module facilitated with the spherical sub-reflector a little, but it is not the optimized illumination efficiency. The optimized illumination efficiency of the lamp module 200 is 100.29% when the distance between the first and the second focuses F1 and F2 is 2.5 mm. Furthermore, all the luminous efficiencies of the lamp module 200 are higher than the illumination efficiencies of the lamp module using the spherical sub-reflector when the distance between the first and the second focuses F1 and F2 of the elliptical sub-reflector 230 is between 2.2 mm and 4.0 mm.

It is noted from analyzing the data diagrams mentioned above, the illumination efficiency of the lamp module 200 using the elliptical sub-reflector 230 in cooperation with the main reflector 220 is higher than the illumination efficiency of the lamp module using spherical reflector. Furthermore, the optimized design of the elliptical sub-reflector 230 is not happened when the first focus F1 and the second focus F2 are disposed on the top ends of the first arc E1 and the second arc E2, the optimized design of the elliptical sub-reflector 230 is happened when the distance between The first focus F1 and the second focus F2 is larger than the initial arc gap Dg. For example, when the initial arc gap is 1.0 mm, the optimized design is that the distance between the Focuses F1 and F2 is 4.0 mm, and when the initial arc gap is 1.3 mm, the optimized design is that the distance between the Focuses F1 and F2 is 2.5 mm.

As mentioned above, although the present invention takes the lamp module 200 comprising the elliptical main reflector 200 as an example to do explanation, the main reflector of the lamp module 200 can also be a parabolic reflector and the focus of the parabolic reflector is positioned on the center O of the light source 210. Besides, the long axis X of the elliptical sub-reflector 230 can also intersect with the central axis Z, and the first focus F1 and the second focus F2 is not positioned at the two sides facing each others outside the range of the gap of the first arc E1 and the second arc E2 at the same time. Only the center O of the light source 210 is positioned on the long axis X of the elliptical sub-reflector 230 and between the first focus F1 and the second focus F2, and the distance between the first focus F1 and the second focus F2 is larger than the initial arc gap Dg, it can then attain to the objects that the illumination efficiency of the lamp module 200 is increased and the sensitivity of illumination efficiency to the arc gap is decreased. Therefore, they all do not depart from the technological scope of the present invention.

The merits of the lamp module and the projection apparatus facilitated therewith disclosed in the embodiments according to the present invention mentioned above are in that the design using the elliptical sub-reflector in cooperation with the main reflector can allow the illumination efficiency of the lamp module to be higher than the one using the spherical sub-reflector, the lifetime of the projection apparatus can be increased, the lamp module can have larger design tolerances, the assembly can be more convenient.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A lamp module, comprising:
a light source, having a first arc and a second arc, a distance between said first arc and said second arc being an initial arc gap, said light source for generating a light beam;
a main reflector, for reflecting said light beam, having a central axis, and said light source disposed on said central axis; and
an elliptical sub-reflector, for reflecting said light beam to said main reflector, wherein said elliptical sub-reflector has a first focus and a second focus, a center of said light source is positioned on a long axis of said elliptical sub-reflector and between said first focus and said second focus, and a distance between said first focus and said second focus is larger than said initial arc gap.

2. The lamp module according to claim 1, wherein said light source is an arc lamp.

3. The lamp module according to claim 1, wherein said main reflector is an elliptical reflector, and a first focus of said elliptical reflector is positioned on said center of said light source.

4. The lamp module according to claim 1, wherein said main reflector is a parabolic reflector, and a focus of said parabolic reflector is positioned on said center of said light source.

5. The lamp module according to claim 1, wherein said long axis of said elliptical sub-reflector coincides with said central axis of said main reflector.

6. The lamp module according to claim 5, wherein said first focus and said second focus are respectively positioned at two sides facing each other outside said initial arc gap.

7. The lamp module according to claim 6, wherein said distance between said first focus and said second focus is smaller than six times of said initial arc gap.

8. The lamp module according to claim 7, wherein said initial arc gap is 11.0 mm.

9. The lamp module according to claim 8, wherein said distance between said first focus and said second focus is between 2.2 mm and 4.0 mm.

10. The lamp module according to claim 1, wherein said lamp module is for using in a projection apparatus.

11. A projection apparatus, comprising:
a lamp module, comprising:
a light source, having a first arc and a second arc, a distance between said first arc and said second arc being an initial arc gap, said light source for generating a light beam;
a main reflector, used for reflecting said light beam, having a central axis, and said light source being disposed on said central axis; and
an elliptical sub-reflector, for reflecting said light beam to said main reflector, wherein said elliptical sub-reflector has a first focus and a second focus, a center of said light source is positioned on a long axis of said elliptical sub-reflector and between said first focus and said second focus, and said distance between said first focus and said second focus is larger than said initial arc gap;
a light valve, disposed on a transmission path of said light beam for converging said light beam in to an imaging light beam; and
a projection lens, disposed on a transmission path of the imaging light beam to project the imaging light beam onto a screen.

12. The projection apparatus according to claim 11, wherein said light source is an arc lamp.

13. The projection apparatus according to claim 11, wherein said main reflector is an elliptical reflector, and a first focus of said elliptical reflector is positioned on said center of said light source.

14. The projection apparatus according to claim 11, wherein said main reflector is a parabolic reflector, and a focus of said parabolic reflector is positioned on said center of said light source.

15. The projection apparatus according to claim 11, wherein said long axis of said elliptical sub-reflector coincides with said central axis of said main reflector.

16. The projection apparatus according to claim 15, wherein said first focus and said second focus are respectively positioned at two sides facing each other outside said initial arc gap.

17. The projection apparatus according to claim 16, wherein said distance between said first focus and said second focus is smaller than six times of said initial arc gap.

18. The projection apparatus according to claim 17, wherein said initial arc gap is 1.0 mm.

19. The projection apparatus according to claim 18, wherein said distance between said first focus and said second focus is between 2.2 mm and 4.0 mm.
